(19) United States
(12) Patent Application Publication
(10) Pub. No.: US 2025/0309985 A1
(43) Pub. Date: Oct. 2, 2025

(54) SYSTEM AND METHOD FOR TRACKING SUBJECTS IN INDOOR SPACES

(71) Applicant: SIGNIFY HOLDING B.V., EINDHOVEN (NL)

(72) Inventors: PETER DEIXLER, ARLINGTON, MA (US); JIN YU, LEXINGTON, MA (US)

(21) Appl. No.: 18/864,065

(22) PCT Filed: May 2, 2023
(86) PCT No.: PCT/EP2023/061480

§ 371 Date: Nov. 8, 2024

Related U.S. Application Data
(60) Provisional application No. 63/339,546, filed on May 9, 2022.

(30) Foreign Application Priority Data
May 16, 2022 (EP) 22173413.0

(51) Int. Cl. H04B 10/114; G01C 21/20; H04B 10/116; H04W 64/00

(52) U.S. Cl. CPC H04B 10/1149; G01C 21/206; H04B 10/116; H04W 64/006

(57) ABSTRACT

A system (100) and method (500) for tracking a position of a subject (110) in an indoor space (120) are provided. The system comprises light sources (130) configured to emit modulated illumination, a scanning device (140) configured to receive the modulated illumination and obtain position information of the scanning device, a wireless communication system (160), a mobile device (170) arranged to be portable by the subject and connectable to the wireless communication system, wherein the mobile device is configured to generate its position data (180) via the wireless communication system, wherein a processor (200) of the system, as a function of at least one predetermined condition (230a-e), is configured to, register a position of the subject based on a position of the scanning device, or obtain position data of the mobile device, and/or register a position of the subject based on the position data of the mobile device.

### FIELD OF THE INVENTION

The present invention generally relates to the tracking or monitoring of one or more subjects in an indoor space. More specifically, the present invention is related to the tracking or monitoring of subject(s) in a commercial space, such as a store.

### BACKGROUND OF THE INVENTION

Today's customers generally want to shop quickly and preferably in one single place, and large retailers with a wide range of products can often meet these customer expectations. A department store or hypermarket stocked with a large variety of products, however, can be a challenge for efficient shopping, both for consumers and workers picking delivery orders.

In a Visual Light Communication (VLC) system, it is assumed that dedicated handheld devices (e.g. self-scanners) will likely be used even more in the future in indoor spaces. For example, in case of the indoor space is a warehouse, store, or the like, the system may enhance the shopping experience and increase sales. Next to being able to help shoppers find products which may be difficult to locate, systems technologies using VLC may generate much data which can be used for customer behavior, predictive queue management, staff scheduling, etc.

However, the handheld device, such as a self-scanner, operated with VLC may sometimes not be able to generate the desired accurate positioning data of a customer. For example, if the customer leaves the self-scanner in the shopping cart, there is no data representative of the customer's movements. Furthermore, other factors may negatively affect the accuracy of the VLC-based self-scanner, such as current speed of the self-scanner, occlusion of the VLC position, the customer's operation of the self-scanner, etc.

Hence, it is an object of the present invention to provide an improved tracking or monitoring of subject(s) (e.g. customers) in (commercial) indoor spaces.

### SUMMARY OF THE INVENTION

It is of interest to further develop the technology in the area of tracking, monitoring or observing the position(s) of subject(s) (e.g. person(s)) in an indoor space.

This and other objects are achieved by providing a system and a method having the features in the independent claims. Preferred embodiments are defined in the dependent claims.

According to a first aspect of the present invention, there is provided a system for tracking a position of at least one subject in an indoor space. The system comprises a plurality of light sources, wherein each light source of the plurality of light sources is configured to emit modulated illumination. The system further comprises a scanning device, arranged to be operable by the at least one subject for scanning of goods, wherein the scanning device is configured to receive the modulated illumination from at least one light source of the plurality of light sources, and obtain position information of the scanning device based on the received modulated illumination. The system further comprises a wireless communication system, and a mobile device arranged to be portable by the at least one subject, wherein the mobile device is connectable to the wireless communication system and wherein the mobile device is configured to generate position data of the mobile device based on a connection to the wireless communication system. The processor is communicatively coupled to the scanning device and the mobile device, wherein the processor is configured to receive the position information from the scanning device. The processor is configured to obtain information of the scanning device and the mobile device, wherein the information comprises position data of the scanning device based on the received position information, and at least one of the position data of the mobile device, and motion data of the mobile device. The processor, as a function of at least one predetermined condition based on the information, is further configured to, handover between registering a position of the at least one subject based on the position of the scanning device, and obtaining position data of the mobile device, and registering a position of the at least one subject based on the obtained position data of the mobile device.

According to a second aspect of the present invention, there is provided a method for tracking a position of at least one subject in an indoor space via a system. The system comprises a plurality of light sources, wherein each light source of the plurality of light sources is configured to emit modulated illumination, a scanning device arranged to be operable by the at least one subject for scanning of goods, wherein the scanning device is configured to receive the modulated illumination from at least one light source of the plurality of light sources, and obtain position information of the scanning device based on the received modulated illumination. The system further comprises a wireless communication system, a mobile device arranged to be portable by the at least one subject, wherein the mobile device is connectable to the wireless communication system and wherein the mobile device is configured to generate position data of the mobile device based on a connection to the wireless communication system. The method comprises receiving the position information from the scanning device, obtaining information of the scanning device and the mobile device, wherein the information comprises position data of the scanning device based on the received position information, and at least one of the position data of the mobile device, and motion data of the mobile device, wherein the method further comprises, as a function of at least one predetermined condition based on the information, handing over between registering a position of the at least one subject based on the position of the scanning device, and obtaining position data of the mobile device, and registering a position of the at least one subject based on the obtained position data of the mobile device.

Thus, the present invention is based on the idea of providing a system and a method for tracking, monitoring or observing subject(s) in an indoor space, wherein the position(s) of the subject(s) is (are) obtained via a VLC-connected scanning device (e.g. a self-scanner) and (/or) a mobile device (e.g. a mobile phone, augmented reality headset, etc.) dependently on one or more predetermined conditions related to the subject(s), the scanning device and (/or) the mobile device. Hence, the system provides a (dynamic) handover between the scanning device and the mobile device for subject positioning. The handover may comprise a change of sensing type used for tracking of a position of the subject from tracking the position via the scanning device to the tracking of the position via mobile device or vice versa.

The present invention is advantageous in that the positioning of subject(s) via the scanning device or via the mobile device may be performed even more accurately compared to existing systems and/or methods. More specifically, the system may, for example, estimate that the subject has (temporarily) left the scanning device, and by tracking/monitoring the subject(s) via its (their) mobile device(s) instead, the accuracy of the positioning may be maintained. Analogously, the system may use the position information via the VLC-operated scanning device based on the predetermined condition(s), for deploying the accuracy of the VLC system.

The present invention is further advantageous in that the system is able to save battery time of the scanning device and/or mobile device. It should be noted the system is configured to register the position of the subject conditionally via the scanning device or the mobile device. Hence, by tracking/monitoring the subject(s) via its (their) scanning device(s) instead of its (their) mobile device(s) (or vice versa) in certain circumstances may include saving of the battery of the scanning device and the mobile device. Furthermore, the system may furthermore be able to safeguard or minimize privacy concerns related to the mobile device.

The present invention is particularly advantageous in indoor spaces such as stores, warehouses, etc., in that the scanning device, at certain times, is with the subject, whereas at other times, the subject may be separated from the scanning device. For example, the system may determine or estimate that the subject/shopper has left the scanning device (e.g. in/on a shopping cart) and continued into isles, to shelves, etc., of the indoor space. The system may hereby adapt the tracking/monitoring conveniently of the subject via handover from the scanning device (e.g. as left in the shopping cart) to the mobile device (e.g. as carried in a pocket of the subject) (and vice versa).

The present invention is further advantageous in that the improved accuracy of the subject(s) position(s) in the indoor space in turn improves any analysis based on this data, such as customer behavior, predictive queue management, staff scheduling, etc.

There is provided a system for tracking a position of at least one subject in an indoor space. By the term “subject”, it is here meant e.g. a person (such as a customer or worker). The system comprises a plurality of light sources, wherein each light source of the plurality of light sources is configured to emit modulated illumination. The system further comprises a scanning device, such as e.g. a self-scanner, arranged to be operable by the at least one subject for scanning of goods. By the term “goods”, it is here meant substantially any goods, items, merchandise, etc., in a (commercial) indoor space. The scanning device is configured to receive the modulated illumination from at least one light source of the plurality of light sources, and obtain position information of the scanning device based on the received modulated illumination, such as Visual Light Communication (VLC). The system further comprises a wireless communication system, and a mobile device arranged to be portable by the at least one subject, wherein the mobile device is connectable to the wireless communication system and wherein the mobile device is configured to generate position data of the mobile device based on a connection to the wireless communication system. By the term “wireless communication system”, it is here meant substantially any communication system to which the mobile device may be connected to in a wireless manner and by which the mobile device may generate its position data. The processor is communicatively coupled to the scanning device and the mobile device, wherein the processor is configured to receive the position information from the scanning device. The processor is configured to obtain information of the scanning device and the mobile device, wherein the information comprises position data of the scanning device based on the received position information. Hence, the processor may be configured to generate the scanning device position based on the obtained information. The information further comprises the position data of the mobile device and/or motion data of the mobile device. By the term “motion data”, it is here meant any data related to a transportation (moving) of the mobile device, a movement (e.g. shaking, lifting, etc.) of the mobile device, etc. The processor, as a function of predetermined condition(s) based on 10 the information, is further configured to either register a position of the subject(s) based on the position of the scanning device, or obtain position data of the mobile device, and register a position of the subject(s) based on the obtained position data of the mobile device. By “predetermined condition(s)”, it is here meant one or more conditions related to the subject(s), scanning device and/or mobile device.

15 According to an embodiment of the present invention, a first predetermined condition of the at least one predetermined condition may be associated with one of a determination, by the processor, of a motion of the scanning device based on the position data of the scanning device, a determination, by the processor, of an immobility of the scanning device based on the position data of the scanning device, and a determination, by the processor, of a height of the scanning device above a floor level of the indoor space based 20 on the position data of the scanning device. Hence, the first predetermined condition may be associated with a motion or immobility of the scanning device, or a height of the scanning device. The present embodiment is advantageous in that the system may efficiently and conveniently register position data via the scanning device or the mobile device as a function 25 of this (first) predetermined condition. For example, if it is determined that the scanning device is in motion, it may be concluded, or at least estimated, that the subject moves together with the scanning device, and the processor may register a position of the subject(s) based on the position of the scanning device. According to another example, via the determined height of the scanning device, the system may determine or estimate that the user 30 (e.g. shopper) has put the scanning device on a scanning device holder in the shopping cart, which may be indicative of the user walking away from the shopping cart.

According to an embodiment of the present invention, the processor may be configured to obtain position data of the mobile device, wherein a second predetermined condition of the at least one predetermined condition is associated with one of a determination, by the processor, of a motion of the at least one subject based on the position data of the mobile device, and a determination, by the processor, of an immobility of the at least one subject based on the position data of the mobile device. Hence, the second predetermined condition may be associated with a motion (e.g. walking, running, etc.) or an immobility (e.g. standing) of the subject(s), and the processor may register a position of the subject(s) via the scanning device or mobile device as a function thereof.

According to an embodiment of the present invention, the processor may be configured to obtain gyro motion data of the mobile device, wherein a third predetermined condition of the at least one predetermined condition is associated with one of a determination, by the processor, of a gyro motion of the mobile device being larger than a first threshold, T₁, and a determination, by the processor, of a gyro motion of the mobile device being smaller than a first threshold, T₁, based on the obtained gyro motion data of the mobile device. Hence, the third predetermined condition is associated with a determination of an occurrence of a gyro motion, or alternatively, of a non-occurrence of a gyro motion, which advantageously contributes to the processor's registration of a position of the subject(s) via the scanning device or mobile device. For example, in case no gyro motion is detected by the processor of the mobile device (possibly also with the detection by the processor of immobility of the mobile device), the processor may register the position of the subject(s) via the scanning device.

According to an embodiment of the present invention, the processor may be configured to obtain position data of the mobile device, wherein a fourth predetermined condition of the at least one predetermined condition is associated with one of a determination, by the processor, of a distance, d, between the scanning device and the mobile device, being larger than a second threshold, T₂, and a determination, by the processor, of a distance, d, between the scanning device and the mobile device, being smaller than a second threshold, T₂, based on the obtained position data of the scanning device and the obtained position data of the mobile device. In other words, the fourth predetermined condition may be associated with the determination of the processor of a relatively short distance between the scanning device and mobile device (i.e. that the scanning device and mobile device are relatively close to each other), or alternatively, of a relatively long distance between the scanning device and mobile device (i.e. that the scanning device and mobile device are relatively far from each other). The embodiment advantageously contributes to the processor's registration of a position of the subject(s) via the scanning device or mobile device. For example, in case the processor detects that the scanning device and mobile device are relatively close to each other, it may register the position of the subject(s) via the scanning device. Alternatively, in case the processor detects that the scanning device and mobile device are relatively far from each other, it may register the position of the subject(s) via the mobile device.

According to an embodiment of the present invention, a fifth predetermined condition of the at least one predetermined condition may be associated with one of a determination, by the processor, of an immobility during a time interval of the scanning device, wherein the immobility is longer than a third threshold, T₃, and a determination, by the processor, of an immobility during a time interval of the scanning device, wherein the immobility is shorter than a third threshold, T₃, based on the position data of the scanning device. Hence, the fifth predetermined condition may be associated with a determination of the processor of a relatively short, or alternatively, relatively long, immobility of the scanning device, which in turn may affect the registering of the position of the subject(s) via the scanning device or the mobile device.

According to an embodiment of the present invention, the processor is configured to register the position of the at least one subject based on the position of the scanning device based on one of a) the first predetermined condition being associated with the determination, by the processor, of a motion of the scanning device based on the position data of the scanning device, b) the first predetermined condition being associated with the determination of the immobility of the scanning device, and the fourth predetermined condition being associated with the determination of the distance, d, being smaller than the second threshold, T₂, c) the first predetermined condition being associated with the determination of the immobility of the scanning device, the second predetermined condition being associated with the determination of the motion of the at least one subject, and the fourth predetermined condition being associated with the determination of the distance, d, being smaller than the second threshold, T₂, d) the first predetermined condition being associated with the determination of the immobility of the scanning device, the fourth predetermined condition being associated with the determination of the distance, d, being larger than the first threshold, T₂, and the fifth predetermined condition being associated with the determination of the immobility during the time interval being shorter than the third threshold, T₃, and e) the first predetermined condition being associated with the determination of the immobility of the scanning device based on the position data of the scanning device, the second predetermined condition being associated with the determination of the motion of the at least one subject, the fourth predetermined condition being associated with the determination of the distance, d, being larger than the second threshold, T₂, and the fifth predetermined condition being associated with the determination of the immobility during the time interval being shorter than the threshold, T₃. Hence, the processor is configured to register the position of the subject(s) based on the position of the scanning device based on one of the five sets of predetermined conditions according to a)-e).

According to an embodiment of the present invention, the processor may be configured to obtain position data of the mobile device and register the position of the at least one subject based on the obtained position data of the mobile device based on the first predetermined condition being associated with the determination of the immobility of the scanning device based on the position data of the scanning device, the second predetermined condition being associated with the determination of the motion of the at least one subject, the fourth predetermined condition being associated with the determination of the distance, d, being larger than the second threshold, T₂, and the fifth predetermined condition being associated with the determination of the mobility during the time interval being shorter than the third threshold, T₃. Hence, the processor is configured to register the position of the subject(s) based on the position of the mobile device based on the present set of predetermined conditions.

According to an embodiment of the present invention, the processor may be configured to obtain position data of the mobile device and register the position of the at least one subject based on the obtained position data of the mobile device based on at least one of a) the first predetermined condition being associated with the determination of the immobility of the scanning device, the second predetermined condition being associated with the determination of the motion of the at least one subject, and the fourth predetermined condition being associated with the determination of the distance, d, being larger than the second threshold, T₂, b) the second predetermined condition being associated with the determination of the immobility of the at least one subject based on the position data of the mobile device, c) the third predetermined condition being associated with the determination of a gyro motion of the mobile device being larger than a first threshold, T₁, and d) the third predetermined condition being associated with the determination of a gyro motion of the mobile device being smaller than a first threshold, T₁. In other words, based on one or more of the four sets of predetermined conditions a)-d), the processor may be configured to register the position of the subject(s) based on the position of the mobile device.

According to an embodiment of the present invention, the processor may be configured to register the position of the at least one subject based on the position of the scanning device based on a) the second predetermined condition being associated with the determination of an immobility of the at least one subject based on the position data of the mobile device, and b) the third predetermined condition being associated with the determination of a gyro motion of the mobile device being smaller than a first threshold, T₁.

According to an embodiment of the present invention, the system may be configured to, at least one of, set the scanning device to a sleep mode, and set the mobile device to a sleep mode. For example, in case the processor is configured to register the position of the subject(s) based on the position of the scanning device, the system may be configured to set the mobile device to a sleep mode. According to another example, in case the processor is configured to register the position of the subject(s) based on the position of the mobile device, the system may be configured to set the mobile device to a sleep mode.

According to an embodiment of the present invention, the processor may be configured to obtain position data of the mobile device, and determine a distance, d, between the scanning device and the mobile device, wherein, in case the determined distance, d, is larger than a fourth threshold, the processor is further configured to estimate position data of the mobile device based on extrapolation of the position data of the scanning device. The embodiment is advantageous in that the system may efficiently determine or estimate that the user has moved away from the scanning device (e.g. upon leaving the scanning device in a shopping cart), and use the (often very accurate) position of the scanning device, as obtained via the VLC system, as position data from which the position data of the mobile device may be determined or estimated based on extrapolation (e.g. via dead-reckoning). The embodiment is particularly advantageous in circumstances the position data of the mobile device via the wireless communication system may be inaccurate.

According to an embodiment of the present invention, the mobile device is configured to estimate at least one path of motion of the mobile device in the indoor space, wherein the mobile device is further configured to update the estimated at least one path of motion based on at least one of a layout of the indoor space, and historic position data comprising at least one of the position data of the scanning device, and position data of the mobile device. Hence, the mobile device may comprise or keep one or more estimated path(s) of motion (e.g. in the form of multiple hypotheses), and based on indoor space layout (e.g. shelves, isles, etc.) and/or historic (saved) position data of the scanning device and/or mobile device, the estimated path(s)/hypotheses may lead to an even further improved estimation of the path of motion of the mobile device (i.e. of the subject) in the indoor space. In turn, this may lead to an improved use of (subject) data, such as e.g. non-real time data of subject (shopper) behavior analytics.

According to an embodiment of the present invention, the processor may be configured to obtain position data of the mobile device, and determine a distance, d, between the scanning device and the mobile device, wherein, in case the determined distance, d, is larger than a fifth threshold, the processor is further configured to determine a motion of the at least one subject based on the position data of the mobile device, determine a motion of the scanning device based on the position data of the scanning device, and at least one of, register a first position of at least one first subject based on the position of the scanning device, and register a second position of at least one second subject based on the obtained position data of the mobile device. Hence, system may determine or estimate that a first subject has moved away from the scanning device and that a second subject moves the scanning device (e.g. that a first subject leaves a shopping cart and a second subject moves (e.g. in another direction) with the shopping cart). The system may hereby conveniently register the first position of at least one first subject based on the position of the scanning device and/or register the second position of at least one second subject based on the obtained position data of the mobile device.

According to an example of the present invention, the indoor space is one of a warehouse, a supermarket, a shop, and a store.

According to an example of the present invention, the mobile device may be one of a wireless transmit/receive unit, WTRU, and a wearable device. The mobile device of the present example in the form of WTRUs, such as mobile telephone(s), is advantageous in that mobile device(s) of this kind are ubiquitously used and carried by people. By the term “wearable device”, it is here meant an electronic device arranged to be worn by a subject (person).

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIG. 1 schematically shows a tracking of a subject an indoor space, and

FIG. 2 schematically shows a system for tracking a position of at least one subject in an indoor space.

### DETAILED DESCRIPTION

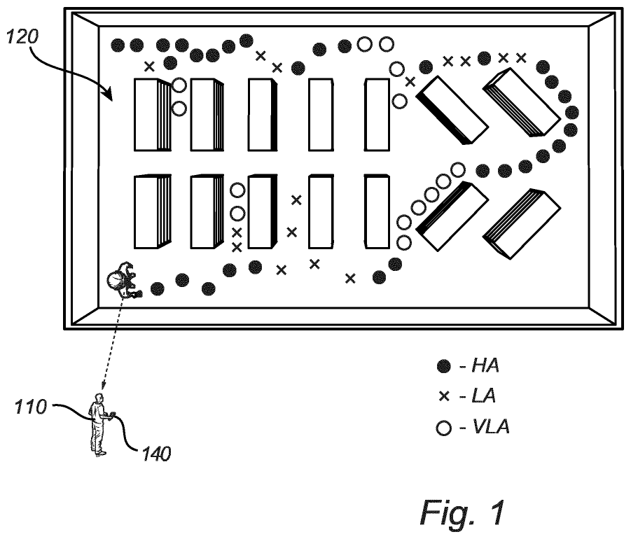

FIG. 1 schematically shows a tracking of a subject 110 in an indoor space 120. The indoor space 120 may be a commercial space such as a warehouse, (retail) store, etc., but may alternatively be a manufacturing facility, or the like. In case of a commercial space such as a store, the indoor space 120 may have everyday goods such as vegetables, dairy products, pet foods, etc., provided in shelves. The subject 110 carries a scanning device 140 for self- scanning of goods. The indoor space 120 is provided with a Visual Light Communication (VLC) system for tracking of the subject 110 via the scanning device 140. By this tracking, position(s) and/or a path of the subject 110 in the indoor space 120 may be indicated or estimated by the VLC system. In the exemplified path of the subject 110 in FIG. 1, the filled dots (“HA”) represent a relatively high accuracy of the position of the subject 110, the crosses (“LA”) represent a relatively low accuracy of the position of the subject 110, and the circles (“VLA”) represent a very low accuracy of the position of the subject 110.

FIG. 1 shows that there is not a sufficient accuracy of the determination of the position of the subject 110, and there may be one or more reasons for this. For example, if the customer leaves the scanning device 140 in the shopping cart, there is no data representative of the subject's 110 movements. Furthermore, other factors may negatively affect the accuracy of the VLC-based scanning device 140, such as current speed of the scanning device 140, occlusion of the VLC position, the subject's operation of the scanning device 140, etc. Hence, there is a wish to provide an improved tracking or monitoring of subject(s) 110 (e.g. customers) in an (commercial) indoor space 120.

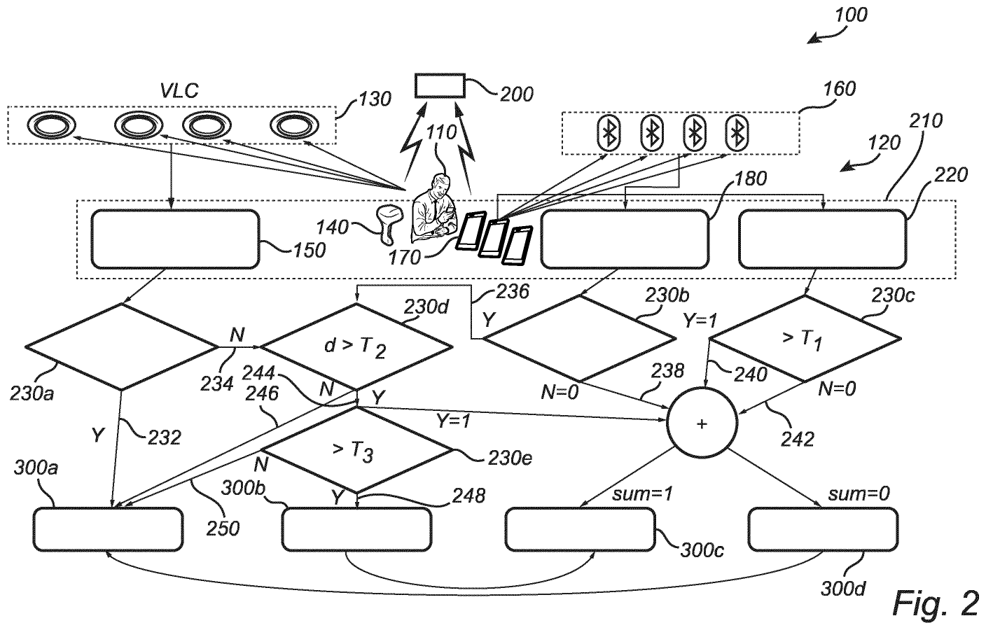

FIG. 2 schematically shows a system 100 for tracking a position of at least one subject 110 (e.g. a person (customer)) in an indoor space 120. The indoor space 120 may be a commercial space such as a warehouse, a supermarket, a shop, a store, or the like, and it may be referred to FIG. 1 and the associated text for an example of such an indoor space 120. It should be noted that the indoor space 120 may alternatively be a manufacturing facility.

The system 100 comprises a plurality of light sources 130, wherein each light source of the plurality of light sources 130 is configured to emit modulated illumination. The system 100 further comprises a scanning device 140, such as e.g. a self-scanner, arranged to be operable by the subject 110 for scanning of goods in the indoor space. It should be noted that in case of the indoor space 120 being a manufacturing facility, factory, or the like, a scanning device 140 may also be used as part of the manufacturing workflow or keeping track of repair workorders or inspection workorders. Furthermore, the scanning device 140 may scan QR codes, but may but may furthermore be configured to use NFC.

The scanning device 140 is configured to receive the modulated illumination from the plurality of light sources 130. Based on this modulated illumination as received, the scanning device 140 is configured to obtain position information of the scanning device 140. Hence, the system may comprise a technology of coded light and/or visible light communication, VLC, whereby the system uses visible light as a method of wirelessly transmitting data. Alternatively, the modulated information may comprise non-visible illumination (e.g. by a LiFi system emitting coded light in the infrared spectrum). The system 100 may furthermore be able to send data in a first visible channel (e.g. blue light) and in a second non-visible channel (IR light). It should be noted that details of coded light, VLC and/or LiFi is known to the skilled person, and details thereof are hereby omitted.

The system 100 further comprises a wireless communication system 160, e.g. Bluetooth Low Energy (BLE) or Ultra Wideband (UWB). The wireless communication system 160 is schematically indicated in FIG. 1, and the positioning, size, etc. thereof is only shown for reasons of understanding. The system 100 further comprises a mobile device 170 arranged to be portable by the subject 110. The mobile device 170 may, for example be a mobile phone (or any kind of a wireless transmit/receive unit, WTRU), a wearable device, or the like. The mobile device 170 may also be or comprise an augmented reality device (e.g. AR glasses). For example, whereas the scanning device 140 may be equipment/property of the indoor space 120 (i.e. a store's scanning device 140 which the subject/customer 110 is allowed to use during shopping), the mobile device 170 may be the subject's 110 personal mobile device 170. The mobile device 170 is connectable to the wireless communication system 160 and the mobile device 170 is configured to generate position data of the mobile device 170 based on a connection to the wireless communication system 160. The mobile device 170 may either receive BLE or UWB beacons (e.g. emitted by the plurality of light source 130) or transmit BLE or UWB beacons (which may be for instance received by a BLE or UWB receiver in the plurality of light sources 130). The mobile phone 170 does not necessarily join the BLE or UWB network.

The system 100 may be configured to perform a pairing of the scanning device 140 and the mobile device 170, e.g. when the subject enters the indoor space 120. The pairing may be achieved through a statistical approach without requiring any user involvement. The pairing may for example be performed in an entrance corridor of the indoor space 120 where a subject (customer) 110 picks up a scanning device 140 before entering the indoor space 120. After successful pairing, the scanning device 140 and the mobile device 170 may be utilized for location tracking purposes.

The system 100 further comprises a processor 200. It should be noted that the processor 200 is merely indicated in FIG. 2 for reasons of understanding. For example, the processor 200 may be part of a server, or the like, of the system 100. The processor 200 is communicatively coupled to the scanning device 140 and the mobile device 170, i.e. connectable to the scanning device 140 and the mobile device 170 by one-way or two-way communication. The processor 200 is configured to receive the position information from the scanning device 140. Hence, the scanning device 140 is configured to send the information of the subject's position 110 to the processor 200.

The processor 200 is configured to obtain (e.g. receive and/or generate) information 210 of the scanning device 140 and the mobile device 110. The information 210 comprises position data 150 of the scanning device 140 based on the received position information. Hence, the processor 200 may be configured to generate the position of the scanning device 140 based on the obtained information. The information 210 further comprises the position data 180 of the mobile device 170 and/or motion data 220 of the mobile device 170.

FIG. 2 further shows a plurality of schematically indicated predetermined conditions 230a-c, wherein the predetermined conditions 230a-c are related to the subject, 110, the scanning device 140 and/or the mobile device 170. Hence, the predetermined conditions 230a-c are based on and/or associated with the information 120 of the scanning device 140 and/or the mobile device 170. The processor 200, as a function of one or more of the predetermined condition(s) 230a-c based on the information 120, is configured to either register a position of the subject 110 based on the position of the scanning device 140, or obtain the position data 180 of the mobile device 170, and register a position of the subject 110 based on the obtained position data 180 of the mobile device 170.

As exemplified in FIG. 1, a first predetermined condition 230a is associated with a determination 232, by the processor 200, of a motion of the scanning device 140 based on the position data 150 of the scanning device 140, or a determination 234, by the processor 200, of an immobility of the scanning device 140 based on the position data 150 of the scanning device 140. The first predetermined condition 230a may furthermore be associated with a determination, by the processor, of a height of the scanning device 140 above a floor level of the indoor space 120 based on the position data 150 of the scanning device 140 (example not shown in FIG. 1).

Hence, the first predetermined condition 230a is associated with either a motion or immobility of the scanning device 140. For example, if it is determined 232 by the processor 200 that the scanning device 140 is in motion, it may be concluded, or at least estimated, by the processor 200 that the subject 110 moves together with the scanning device 140, and the processor 200 may register a position of the subject 110 based on the position data 150 of the scanning device 140.

The processor 200 may be configured to obtain the position data 180 of the mobile device 170, wherein a second predetermined condition 230b is associated with a determination 236, by the processor 200, of a motion of the subject 110 based on the position data 180 of the mobile device 170, or a determination 238, by the processor 200, of an immobility of the subject 110 based on the position data 180 of the mobile device 170. Hence, the second predetermined condition 230b is associated with a motion (e.g. walking, running, etc.) or an immobility (e.g. standing) of the subject 110 in the indoor space 120, and the processor 200 may register a position of the subject 110 via the scanning device 140 or mobile device 170 as a function thereof. For example, the system 100 may determine or estimate that the subject 110 moves (e.g. away from the shopping cart).

The processor 200 may further be configured to obtain gyro motion data 200 of the mobile device 110. A third predetermined condition 230c may hereby be associated with a determination 240, by the processor 200, of a gyro motion of the mobile device 170 being larger than a first threshold, T₁, or a determination 242, by the processor 200, of a gyro motion of the mobile device 170 being smaller than a first threshold, T₁, based on the obtained gyro motion data 200 of the mobile device 170. Hence, the third predetermined condition 230c is associated with a determination 240 of an occurrence of a gyro motion of the mobile device 170, or alternatively, of a determination 242 of a non-occurrence of a gyro motion of the mobile device 170. For example, in case no gyro motion of the mobile device 170 is determined/detected by the processor 200, the processor 200 may register the position of the subject 110 via the scanning device 140.

The processor 200 may further be configured to obtain the position data 180 of the mobile device 170, wherein a fourth predetermined condition 230d is associated with a determination 244, by the processor 200, of a distance, d, between the scanning device 140 and the mobile device 170, being larger than a second threshold, T₂, or a determination 246, by the processor 200, of a distance, d, between the scanning device 140 and the mobile device 170, being smaller than a second threshold, T₂, based on the obtained position data 150 of the scanning device 140 and the obtained position data 180 of the mobile device 170. In other words, the fourth predetermined condition 230d may be associated with the determination 244 of the processor 200 of a relatively short distance between the scanning device 140 and the mobile device 170 in the indoor space 120 (i.e. that the scanning device 140 and the mobile device 170 are relatively close to each other), or alternatively, of a relatively long distance between the scanning device 140 and the mobile device 170 in the indoor space 120 (i.e. that the scanning device 140 and the mobile device 170 are relatively far from each other). For example, in case the processor 200 determines/detects that the scanning device 140 and the mobile device 170 are relatively close to each other, it may register the position of the subject 110 via the scanning device 140. Alternatively, in case the processor 200 detects that the scanning device 140 and mobile device 170 are relatively far from each other, it may register the position of the subject 110 via the mobile device 170.

In FIG. 2, a fifth predetermined condition 230e is associated with a determination 248, by the processor 200, of an immobility during a time interval of the scanning device 140, wherein the immobility is longer than a third threshold, T₃, or a determination 250, by the processor 200, of an immobility during a time interval of the scanning device 140, wherein the immobility is shorter than a third threshold, T₃, based on the position data 150 of the scanning device. Hence, the fifth predetermined condition 230e may be associated with a determination of the processor 200 of a relatively short, or alternatively, relatively long, immobility of the scanning device 140, which in turn may affect the registering of the position of the subject 110 in the indoor space 120 via the scanning device 140 or via the mobile device 170.

By the predetermined conditions 230a-e as exemplified, the system 100 may be configured to register the subject's 110 position via the position 150 of the scanning device 140 or via the position 150 of the mobile device 170. For example, the processor 200 is configured to register the position of the subject 110 based on the position 150 of the scanning device 140 if at least one of the following scenarios/events a)-e) is fulfilled by the processor 200:
a) the first predetermined condition 230a being associated with the determination 232 of a motion of the scanning device 140 based on the position data 150 of the scanning device 140,
b) the first predetermined condition 230a being associated with the determination 234 of the immobility of the scanning device 140, and the fourth predetermined condition 230d being associated with the determination 246 of the distance, d, being smaller than the second threshold, T₂,
c) the first predetermined condition 230a being associated with the determination 234 of the immobility of the scanning device 140, the second predetermined condition 230b being associated with the determination 236 of the motion of the subject 110, and the fourth predetermined condition 230d being associated with the determination 246 of the distance, d, being smaller than the second threshold, T₂,
d) the first predetermined condition 230a being associated with the determination 234 of the immobility of the scanning device 140, the fourth predetermined condition 230d being associated with the determination 244 of the distance, d, being larger than the first threshold, T₂, and the fifth predetermined condition 230e being associated with the determination 250 of the immobility during the time interval being shorter than the third threshold, T₃, and
e) the first predetermined condition 230a being associated with the determination of the immobility of the scanning device based on the position data 150 of the scanning device 140, the second predetermined condition 230b being associated with the determination 236 of the motion of the subject 110, the fourth predetermined condition 230d being associated with the determination 244 of the distance, d, being larger than the second threshold, T₂, and the fifth predetermined condition 230e being associated with the determination 250 of the immobility during the time interval being shorter than the threshold, T₃.

As yet another example of the processor's 200 registering of the position of the subject 110 based on the position 150 of the scanning device 140 is based on
a1) the second predetermined condition 230b being associated with the determination 238 of an immobility of the subject 110 based on the position data 180 of the mobile device 170, and
b1) the third predetermined condition 230c being associated with the determination 242 of a gyro motion of the mobile device 170 being smaller than a first threshold, T₁.

Hence, the processor 200 of the system 100 is configured to register the position of the subject 110 based on the position 150 of the scanning device 140 based on one of the five sets of predetermined conditions according to a)-e) and/or the two sets of predetermined conditions according to a1) and b1).

Alternatively, the processor 200 of the system 100 may be configured to obtain the position data 180 of the mobile device 170 and register the position of the subject 110 in the indoor space 120 based on the obtained position data 180 of the mobile device 170 via the first predetermined condition 230a being associated with the determination 234 of the immobility of the scanning device 140 based on the position data 150 of the scanning device 140, the second predetermined condition 230b being associated with the determination 236 of the motion the subject 110, the fourth predetermined condition 230d being associated with the determination of the distance, d, being larger than the second threshold, T₂, and the fifth predetermined condition 230e being associated with the determination 248 of the mobility during the time interval being shorter than the third threshold, T₃. Hence, the processor 220 is configured to register the position of the subject 110 based on the position 180 of the mobile device 170 based on the present set of predetermined conditions 230a, 230b, 230d, 230e.

As yet another alternative example of the processor 200 being configured to register the position of the subject 110 based on the obtained position data 180 of the mobile device 170 may be based on at least one of the following scenarios/events:
a2) the first predetermined condition 230a being associated with the determination 234 of the immobility of the scanning device 140, the second predetermined condition 230b being associated with the determination 236 of the motion of the subject 110, and the fourth predetermined condition 230d being associated with the determination 244 of the distance, d, being larger than the second threshold, T₂,
b2) the second predetermined condition 230b being associated with the determination 238 of the immobility of the subject 110 based on the position data 180 of the mobile device 170,
c2) the third predetermined condition 230c being associated with the determination 240 of a gyro motion of the mobile device 170 being larger than a first threshold, T₁, and
d2) the third predetermined condition 230c being associated with the determination 242 of a gyro motion of the mobile device 170 being smaller than a first threshold, T₁.

In other words, based on one or more of the four sets of predetermined conditions a2)-d2), the processor 200 of the system 100 may be configured to register the position of the subject 110 in the indoor space based on the position 180 of the mobile device 170.

The registering by the processor 200 of the system 100 of the position of the subject 110 based on the position 150 of the scanning device 140 or the position 180 of the mobile device 170 may be deployed in many different ways. For example, after the mobile phone 170 and the scanning device 140 have been paired, the (an application of the) mobile device 170 may be put to a sleep mode whenever the subject 110 is walking with the shopping cart. However, the system 100 may (continuously) look for evidence indicating that the subject 110 is starting to move away from his/her shopping cart. For instance, this can be detected by monitoring, after the cart has come to a full stop, the mobile device's 170 gyro meter data for movements indicative of the subject 110 having walked several steps. Upon realizing that the subject 110 may have started to move further away from the cart, the system 100 may “wake up” the mobile device 170 and may ask the mobile device 170 to start registering its BLE asset tracking and gyro meter data. Optionally, the mobile device 170 may store, even when the subject 110 is away from the cart, no tracking/gyro data whenever the subject 110 has been standing (statically) for a while. When the system 100 has estimated that the subject 110 indeed has walked away beyond a certain distance threshold from the scanning device 140, it may trigger the mobile device 170 to perform mobile device 170 tracking and instructs it to take over the location-tracking task from the scanning device 140. The handover of the location tracking task may be performed as follows: after the subject 110 carrying the mobile device 170 has walked away from the shopping cart with a docked scanning device 140, a mobile device 170 application may retrieve the last known location from the scanning device 140 (as determined by the very accurate VLC localization engine) and send the scanning device 140 to a sleep mode. Most of the time, the subject's 110 mobile device 170 will remain in his/her pocket, and there may be a need to activate the BLE-based positioning: in this case the BLE positioning system retrieves the starting position (=latest cart position) as determined by the more accurate VLC location engine. The mobile device 170 may record and store the BLE tracking data and fine-motion movement data whenever it is relevant (specifically after the mobile device 170 has been triggered that the subject 110 has left the cart behind). When having been instructed to store data, the mobile device 170 could either locally send its recorded data via BLE to the scanning device 140 and/or first pre-process the data on the mobile device 170. This pre-processing ensures there is only little data transferred from the mobile device 170. In addition, sharing only higher abstraction level is advantageous from a privacy perspective.

It will be appreciated that one or more of the predetermined conditions 230a-e may be updated based on machine learning (ML) to personalize the conditions. For instance, the ML system may learn that a (first) subject 110 generally moves with the shopping cart and only leaves the cart for a couple of meters. A (second) subject 110 may have a routine to leave the cart at one central location e.g. at the beginning of a grocery isle in the indoor space 120 and then roam around freely to pick up merchandize. In the second case, as soon as the subject is only e.g. 2 m away from the cart, the system 100 may activate the mobile device 170 and/or the wireless communication system 160 as the system 100 knows from the past that the second subject 110 most likely will leave the cart behind.

In case the processor 200 of the system 100 registers the position of the subject 110 based on the position of the scanning device 140, the system 100 may be configured to maintain or (re) activate the VLC system and/or positioning of the scanning device 140 as exemplified by box 300a. The system 100 may, accordingly, set the mobile device 170 to a sleep mode, or (temporary) inactivation of the mobile device 170, as indicated schematically by box 300d. Analogously, in case the processor 200 of the system 100 registers the position of the subject 110 based on the position 180 and/or motion data 220 of the mobile device 170, the system 100 may be configured to maintain or (re)activate the wireless communication system 160 and/or positioning of the mobile device 170 as exemplified by box 300c. The system 100 may, accordingly, set the scanning device 140 to a sleep mode, or (temporary) inactivation of the scanning device 140, as indicated schematically by box 300b.

In contrast to localization only via BLE, the system 100 according to the present invention can accurately determine the height of the scanning device 140 by triangulating based on the VLC signals from the plurality of light sources 130. The height of the scanning device 140 may be used to discern whether the scanning device 140 is currently placed on/inside a shopping cart (i.e. remains at a fixed height) or possibly held in the hand by a subject 110 (i.e. different height from the bottom of the cart).

According to an example, if the subject 110 shopper walks away from his cart, the joint movement trajectory of the scanning device 140 and the mobile device 170 may terminate and the scanning device 140 and mobile device 170 may exhibit two distinct movement trajectories. The BLE may have a limited location tracking accuracy (compared to the superior location tracking abilities of the (left behind) scanning device 140). Fortunately, from the VLC data, the subject's 110 (customer's) true movement direction just before the location-tracking task was handed over from the scanning device 140 to the mobile device 170.

Unlike the BLE-based location tracking of the mobile device 170, the VLC-based system of the scanning device 140 may accurately determine the 3D-spatial-orientation of the scanning device 140. Hence, from the VLC system, the direction of movement of the subject 110 in the indoor space 120 may be known. Upon the system's 100 recognition that the subject 110 has walked away from the scanning device 140 (which, for example, has been left behind in the cart), the mobile device's BLE-based location tracking algorithm ingests from the VLC system the latest precisely known location of the subject 110 in the indoor space 120. The mobile device's 170 BLE-based localization system (i.e. the wireless communication system 160) may thereby use this data as an anchor/pivot point for extrapolating the further motion trail of the subject 110 based on the BLE signals of the mobile device 170 as well as the mobile device's 170 gyro and accelerometer data.

The mobile device 170 may at first keep multiple hypothesis about the subject's 110 BLE-derived motion path alive in parallel and then gradually eliminate the disproven hypothesis. As the main purpose of the semi-dead-reckoned motion trail data (BLE+gyro of the mobile device) is for non-real-time data shopper-behavior analytics to be performed by the retailer (and not for real-time wayfinding of the subject/customer), several competing scenarios about the motion trail may be stored in a data lake of the system 100. Hence, the decision which scenario to use is only made later in time (with the benefit of hindsight). For instance, the retailer may also use historic data from previous shopping trips of the same subject 110 (or from other comparable subjects 110) to decide which of the multitude of hypothesis to select. For instance, the system 100 may utilize historic data where the subject 100 had the personal mobile device 170 in a wayfinding mode and hence both the VLC data and BLE data was recorded while at the same time the subject 110, when walking away from the scanning device 140 in the cart, was holding his/her personal mobile device 170 while picking products from the retail shelf. In the latter case, the concurrent VLC data may be used by the system 100 as the ground truth to label a first motion trail recorded by the BLE tracking and gyroscope. The labelled first BLE motion trail may then be used for discerning the likeliness of a second BLE motion trail hypothesis. In addition, the hypothesis analysis can of course also take the layout of the indoor space 120 into account. For instance, whenever a motion trail hypothesis starts extending right through a retail shelf (which is physically impossible), this specific hypothesis may be disproved.

As the subject 110 eventually will come back to the cart, the motion trail of the mobile device 170 and the motion trail of the scanning device 140 will eventually merge again into a single, joint motion trail. As soon as the subject 110 again pushes his shopping cart, the VLC system can again provide the precise orientation of the subject's 110 torso to the mobile devices 170 location engine. This insight can be used by the mobile device's 170 location tracking system to disprove, with the benefit of hindsight, certain hypotheses about the recent dead reckoned motion trail. For the benefit of non-real-time data analytics by the retailer, the system 100 may annotate the dead reckoned motion trail with an accuracy indicator expressing the confidence level in the given position estimates while the subject 110 was away from the shopping cart.

By the system 100 of the present invention, one purpose of the combination of BLE and gyro motion may be for non-real-time data shopper-behavior analytics to be performed by the retailer. The retailer may also use historic data from previous shopping trips of the same subject 110 (or from other comparable subjects 110). For instance, the system 100 may utilize historic data where the subject 110 had the personal mobile device 170 in wayfinding mode and hence both the VLC data and BLE data was recorded by the mobile device 170 while at the same time the subject 110, when walking away from the scanning device 140 in the cart, is holding his personal mobile device 170.

According to an example, the BLE position of the mobile device 170 may be monitored by the system 100 periodically and the distance may be checked between the mobile device 170 and the scanning device 140. If it is larger than the threshold and both the scanning device 140 and the mobile device 170 are independently in motion, the system 100 may conclude that there must be a (first) subject 110 who is pushing the cart and a (second) subject 110 who is carrying the mobile device 170 and searches for shopping items away from the cart. Under this special circumstance, the navigation may be active on both the mobile device 170 (BLE) and the scanning device (VLC). When the subjects 110 switch roles and the other subject 110 starts pushing the cart, there scanning device 140 may exhibit a brief stop which enables the system 100 to again associate the mobile device 170 as moving now in concert with the scanning device 140 again. Despite the switching of the cart-pushing roles is happening very fast (and can hence easily missed by the BLE tracking system), the system 100 can detect with the benefit of hindsight at which moment the different subject 110 started to push the cart.

According to an example, a retailer of the indoor space 120 may be interested in which direction the subject 110 is facing at any given time. This can be achieved by utilizing the initial facing direction of the subject 110 (as determined by the VLC-equipped scanning device 140) and then dead reckon the new facing direction of the subject 110 based on the mobile device's 170 gyro meter data. The combination of dead reckoned motion trail data and the subject's 110 facing-direction data may be helpful for indoor space 120 layout optimization, for instance to minimize the travel path and improve the shopping efficiency (in order to find items easily).

It will also be appreciated that thanks to the system's 100 involving of both a mobile device 170 and a scanning device 140 for positioning, it is possible to seamlessly monitor in real-time the subject's 110 (customer's) actions. For instance, real time data analytics may enable the retailer to identify that a subject 110 is looking for his left-behind shopping cart, the mobile device 170 can then point the subject 110 to his/her cart location in the store and/or alert the subject 110 if he/she has accidentally taken the wrong cart.

The person skilled in the art realizes that the present invention by no means is limited to the preferred embodiments described above. On the contrary, many modifications and variations are possible within the scope of the appended claims.

1. A system for tracking a position of at least one subject in an indoor space, comprising
a plurality of light sources, wherein each light source of the plurality of light sources is configured to emit modulated illumination,
a scanning device, arranged to be operable by the at least one subject for scanning of goods, wherein the scanning device is configured to
receive the modulated illumination from at least one light source of the plurality of light sources, and
obtain position information of the scanning device based on the received modulated illumination,
a wireless communication system,
a mobile device arranged to be portable by the at least one subject, wherein the mobile device is connectable to the wireless communication system and wherein the mobile device is configured to
generate position data of the mobile device based on a connection to the wireless communication system,
a processor communicatively coupled to the scanning device and the mobile device, wherein the processor is configured to
receive the position information from the scanning device,
obtain information of the scanning device and the mobile device, wherein the information comprises
position data of the scanning device based on the received position information, and
at least one of
the position data of the mobile device, and
motion data of the mobile device,
wherein the processor, as a function of at least one predetermined condition based on the information, is further configured to, handover between
registering a position of the at least one subject based on the position of the scanning device, and
obtaining position data of the mobile device and registering a position of the at least one subject based on the obtained position data of the mobile device.

2. The system according to claim 1, wherein a first predetermined condition of the at least one predetermined condition is associated with one of
a determination, by the processor, of a motion of the scanning device based on the position data of the scanning device,
a determination, by the processor, of an immobility of the scanning device based on the position data of the scanning device, and
a determination, by the processor, of a height of the scanning device above a floor level of the indoor space based on the position data of the scanning device.

3. The system according to claim 1, wherein the processor is configured to obtain position data of the mobile device, wherein a second predetermined condition of the at least one predetermined condition is associated with one of
a determination, by the processor, of a motion of the at least one subject based on the position data of the mobile device, and
a determination, by the processor, of an immobility of the at least one subject based on the position data of the mobile device.

4. The system according to claim 1, wherein the processor is configured to obtain gyro motion data of the mobile device, wherein a third predetermined condition of the at least one predetermined condition is associated with one of
a determination, by the processor, of a gyro motion of the mobile device being larger than a first threshold, T₁, and
a determination, by the processor, of a gyro motion of the mobile device being smaller than a first threshold, T₁,
based on the obtained gyro motion data of the mobile device.

5. The system according to claim 1, wherein the processor is configured to obtain position data of the mobile device, wherein a fourth predetermined condition of the at least one predetermined condition is associated with one of
a determination, by the processor, of a distance, d, between the scanning device and the mobile device, being larger than a second threshold, T₂, and
a determination, by the processor, of a distance, d, between the scanning device and the mobile device, being smaller than a second threshold, T₂,
based on the obtained position data of the scanning device and the obtained position data of the mobile device.

6. The system according to claim 1, wherein a fifth predetermined condition of the at least one predetermined condition is associated with one of
a determination, by the processor, of an immobility during a time interval of the scanning device, wherein the immobility is longer than a third threshold, T₃,
a determination, by the processor, of an immobility during a time interval of the scanning device, wherein the immobility is shorter than a third threshold, T₃,
based on the position data of the scanning device.

7. The system according to claims 2, wherein the processor is configured to register the position of the at least one subject based on the position of the scanning device based on one of
the first predetermined condition being associated with the determination, by the processor, of a motion of the scanning device based on the position data of the scanning device,
the first predetermined condition being associated with the determination of the immobility of the scanning device, and the fourth predetermined condition being associated with the determination of the distance, d, being smaller than the second threshold, T₂,
the first predetermined condition being associated with the determination of the immobility of the scanning device, the second predetermined condition being associated with the determination of the motion of the at least one subject, and the fourth predetermined condition being associated with the determination of the distance, d, being smaller than the second threshold, T₂,
the first predetermined condition being associated with the determination of the immobility of the scanning device, the fourth predetermined condition being associated with the determination of the distance, d, being larger than the first threshold, T₂, and the fifth predetermined condition being associated with the determination of the immobility during the time interval being shorter than the third threshold, T₃, and
the first predetermined condition being associated with the determination of the immobility of the scanning device based on the position data of the scanning device, the second predetermined condition being associated with the determination of the motion of the at least one subject, the fourth predetermined condition being associated with the determination of the distance, d, being larger than the second threshold, T₂, and the fifth predetermined condition being associated with the determination of the immobility during the time interval being shorter than the threshold, T₃.

8. The system according to claims 2, wherein the processor is configured to obtain position data of the mobile device and register the position of the at least one subject based on the obtained position data of the mobile device based on
the first predetermined condition being associated with the determination of the immobility of the scanning device based on the position data of the scanning device, the second predetermined condition being associated with the determination of the motion of the at least one subject, the fourth predetermined condition being associated with the determination of the distance, d, being larger than the second threshold, T₂, and the fifth predetermined condition being associated with the determination of the mobility during the time interval being shorter than the third threshold, T₃.

9. The system according to claim 2, wherein the processor is configured to obtain position data of the mobile device and register the position of the at least one subject based on the obtained position data of the mobile device based on at least one of
the first predetermined condition being associated with the determination of the immobility of the scanning device, the second predetermined condition being associated with the determination of the motion of the at least one subject, and the fourth predetermined condition being associated with the determination of the distance, d, being larger than the second threshold, T₂,
the second predetermined condition being associated with the determination of the immobility of the at least one subject based on the position data of the mobile device,
the third predetermined condition being associated with the determination of a gyro motion of the mobile device being larger than a first threshold, T₁, and
the third predetermined condition being associated with the determination of a gyro motion of the mobile device being smaller than a first threshold, T₁.

10. The system according to claim 3, wherein the processor is configured to register the position of the at least one subject based on the position of the scanning device based on
the second predetermined condition being associated with the determination of an immobility of the at least one subject based on the position data of the mobile device, and
the third predetermined condition being associated with the determination of a gyro motion of the mobile device being smaller than a first threshold, T₁.

11. The system according to claim 7, being configured to, at least one of,
set the scanning device to a sleep mode, and
set the mobile device to a sleep mode.

12. The system according to claim 1, wherein the processor is configured to
obtain position data of the mobile device, and
determine a distance, d, between the scanning device and the mobile device, wherein, in case the determined distance, d, is larger than a fourth threshold, the processor is further configured to
estimate position data of the mobile device based on extrapolation of the position data of the scanning device.

13. The system according to claim 1, wherein the mobile device is configured to estimate at least one path of motion of the mobile device in the indoor space, wherein the mobile device is further configured to update the estimated at least one path of motion based on at least one of
a layout of the indoor space, and
historic position data comprising at least one of
the position data of the scanning device, and
position data of the mobile device.

14. The system according to claim 1, wherein the processor is configured to
obtain position data of the mobile device, and
determine a distance, d, between the scanning device and the mobile device, wherein, in case the determined distance, d, is larger than a fifth threshold, the processor is further configured to
determine a motion of the at least one subject based on the position data of the mobile device,
determine a motion of the scanning device based on the position data of the scanning device, and
at least one of,
register a first position of at least one first subject based on the position of the scanning device, and
register a second position of at least one second subject based on the obtained position data of the mobile device.

15. A method for tracking a position of at least one subject in an indoor space via a system comprising
a plurality of light sources, wherein each light source of the plurality of light sources is configured to emit modulated illumination,
a scanning device, arranged to be operable by the at least one subject for scanning of goods, wherein the scanning device is configured to
receive the modulated illumination from at least one light source of the plurality of light sources, and
obtain position information of the scanning device based on the received modulated illumination,
a wireless communication system,
a mobile device arranged to be portable by the at least one subject, wherein the mobile device is connectable to the wireless communication system and wherein the mobile device is configured to
generate position data of the mobile device based on a connection to the wireless communication system,
wherein the method comprises
receiving the position information from the scanning device,
obtaining information of the scanning device and the mobile device, wherein the information comprises
position data of the scanning device based on the received position information, and
at least one of
the position data of the mobile device, and
motion data of the mobile device,
wherein the method further comprises, as a function of at least one predetermined condition based on the information, handing over between
registering a position of the at least one subject based on the position of the scanning device, and
obtaining position data of the mobile device, and registering a position of the at least one subject based on the obtained position data of the mobile device.
